(19) United States
(12) Patent Application Publication
(10) Pub. No.: US 2017/0310553 A1
(43) Pub. Date: Oct. 26, 2017

(54) SYSTEMS AND METHODS FOR MULTI MODAL COMMUNICATION

(71) Applicant: BUTLER SOLUTIONS, LLC, MCLEAN, VA (US)

(72) Inventors: ANDREW V. WELTERS, MCLEAN, VA (US); JAMES LAKE, LOS ANGELES, CA (US)

(73) Assignee: BUTLER SOLUTIONS, LLC

(21) Appl. No.: 15/493,213

(22) Filed: Apr. 21, 2017

Related U.S. Application Data
(60) Provisional application No. 62/326,495, filed on Apr. 22, 2016.

(51) Int. Cl. H04L 12/24; H04W 48/10; H04W 8/22; H04W 76/02; H04W 48/16; H04W 88/16; H04W 84/18; H04W 88/06

(52) U.S. Cl. CPC H04L 41/12; H04W 76/025; H04W 48/10; H04W 48/16; H04W 8/22; H04W 84/18; H04W 88/06; H04W 88/16

(57) ABSTRACT

A multi modal communication system for sending and receiving transmissions may be disclosed. The multi modal communication system may include a server device that is configured to selectively send and receive communication across multiple communication paths. The communications paths may include at least a first communication path and an alternative communication path. The multimodal communication system may include numerous nodes, at least one node being a gateway node, a relay node, or a client node. The plurality of nodes may communicate with the server device, communicate between respective nodes using a message routing and forwarding protocol, and maintain a network map. Additionally, some nodes may be configured to communicate wirelessly with the at least one client node. Furthermore, the gateway node may be configured to directly communicate with the at least one server device via the alternative communication path.

### PRIORITY INFORMATION

This application claims the benefit of U.S. Provisional Patent Application No. 62/326,495, filed Apr. 22, 2016, which is incorporated herein by reference in its entirety.

### TECHNICAL FIELD

The present disclosure relates generally to data networks that provide complete and reliable communication within various venues. In particular, the present disclosure is directed to systems and methods for multi modal communication, such as mobile offline communication.

### BACKGROUND

Existing data networks lack reliability and security. These networks are particularly unreliable in locations with marginal communication capability. A mobile device may be incapable of communicating directly with the Internet in the event that the mobile device does not have cellular reception and/or is not connected over Wi-Fi. Similarly, a mobile device may be incapable of communicating directly with the Internet in a crowded area, such as an event stadium, because the existing mobile device network(s) are overloaded due to crowding. In these and other problematic instances, a mobile device may be incapable of communicating with a particular server.

The disclosed systems and methods for multi modal communication are directed to overcoming one or more of the problems of existing data networks, particularly by providing a system and method for mobile offline communication across a mesh network.

### SUMMARY

In one respect, a multi modal communication system for sending and receiving transmissions may include a server device that is configured to selectively send and receive communication across multiple communication paths. The communications paths may include at least a first communication path and an alternative communication path. The multimodal communication system may include numerous nodes, at least one node being a gateway node, a relay node, or a client node. The plurality of nodes may communicate with the server device, communicate between respective nodes using a message routing and forwarding protocol, and maintain a network map. Additionally, some nodes may be configured to communicate wirelessly with the at least one client node. Furthermore, the gateway node may be configured to directly communicate with the at least one server device via the alternative communication path.

In another respect, a multi modal communication system for sending and receiving transmissions may include a server device that is configured to selectively send and receive communication across multiple communication paths The communication paths may include at least one communication channel. The multi modal communication system may include a plurality of nodes, at least one node being a gateway node, a relay node, or a client node. The plurality of nodes may communicate with the at least one server device using a forwarding protocol, and communicate between respective nodes using the forwarding protocol according to a common communication channel. The nodes may also maintain a network map and tag marked messages. Additionally, at least one of the plurality of nodes may be configured to communicate wirelessly with the at least one client node, and the at least one gateway node may be configured to communicate with the at least one server device according to a first communication channel. Furthermore, a mobile device may be in communication with the at least one server device. The mobile device may be configured to selectively communicate with the at least one server device across a first communication path, an alternative communication path, or both.

In another respect, a method for sending and receiving transmissions may be disclosed. The method may include sending a transmission across a mesh network, and receiving a transmission from the mesh network by a server device. Sending the transmission may include relaying the transmission according to a message routing and forwarding protocol across a plurality of nodes configured as the mesh network, and forwarding the transmission to the server device by a gateway node across the Internet.

### BRIEF DESCRIPTION OF THE DRAWINGS

FIG. 1 is an exemplary system diagram depicting communication between a user endpoint and a server:

FIG. 2 is an exemplary flow chart depicting an exemplary multi modal communication decision process;

FIG. 3 is an exemplary node communication network;

FIG. 4 is an exemplary flow chart depicting the generation of a network map; and

FIG. 5 is an exemplary flow chart of a message inspection and forwarding protocol.

### DETAILED DESCRIPTION

Disclosed embodiments relate to systems and methods for multi modal wireless communication. In some embodiments, the disclosed embodiments address shortcomings of existing data networks to provide complete and reliable communication, e.g., within crowded areas. A mobile device, a mesh network, and/or a server device can be designed to use multi modal communication protocols. These communication paths and protocols, in some embodiments, may greatly increase communication reliability.

In some embodiments, communication should be broadly understood to mean the sending and receiving of electronic data via wireless and wired transmissions as would be understood by a person having ordinary skill in the art. Exemplary communication networks may be Bluetooth. IEEE, 802.11 (“Wi-Fi”) 802.15, 802.15.4 (“ZigBee”), 802.16 (“Wimax”), or the like.

In some embodiments, a Bluetooth communication network can be deployed in an area, such as a stadium, school, office, industrial facility, park, or home. The network may provide an alternative communication path for user devices. Exemplary user devices may be mobile devices such as desktops, laptops, PDAs, Tablets, appliances, smartphones, or the like. Many of these devices communicate over the Internet via preexisting cellular or wireless network infrastructure e.g., using Wi-Fi and/or cell phone towers. An object of the present disclosure is to use an alternative communication path in parallel with existing communication channels and preexisting network infrastructure. In some embodiments, other network technologies that are functionally equivalent to those discussed may be used. Throughout this disclosure, Bluetooth is recited as an exemplary communication channel type and communication network type. However, it should be understood that any communication channel type and communication network type or combination thereof may be used.

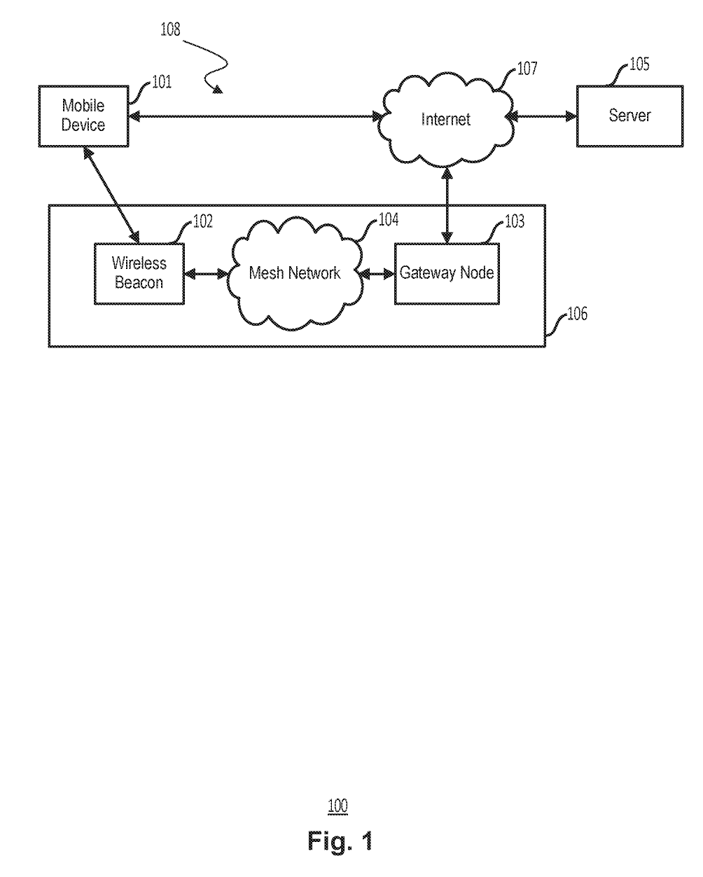

FIG. 1 is an exemplary system diagram depicting communication between a user endpoint and a server. FIG. 1 may depict an exemplary system that may provide multi modal communication between a mobile device 101, also referenced as a user endpoint, and a server device 105. FIG. 1 may disclose exemplary multi modal communication between mobile device 101 and server device 105 across pre-existing cellular infrastructure and across alternative communication path 106. Specifically, FIG. 1 illustrates how multi modal communication may be implemented in an order submission and confirmation system. In some embodiments, multi modal communication may be understood as communication that may selectively occur over multiple distinct network paths according to multiple communication types of communication channels.

Communication between mobile device 101 and server device 105 may be conducted in private to ensure that sensitive details (credit card numbers, passwords, etc.) are not exposed. In some embodiments, a shared secret key may be sent between mobile device 101 and server device 105 across Internet 107 by a secure mechanism, e.g., HTTPS (“Hypertext Transfer Protocol Secure”). Alternatively, some embodiments may use public key encrypted messaging that is only accessible by server 105. In still further embodiments, sensitive communications may be sent between mobile device 101 and server 105 over specific communication channels that provide for encryption, e.g., link level encryption.

Mobile device 101 may be any wireless communication device, e.g., desktops, laptops, PDAs, Tablets, appliances, smartphones, or the like. Mobile device 101 may selectively utilize existing connectivity to Internet 107 across first communication path 108. Additionally, mobile device 101 may selectively utilize alternative communication path 106. In some embodiments, mobile device 101 may support a discrete number of communication channels (Wi-Fi, Cellular, and Bluetooth). Alternative communication path 106 may include at least one wireless beacon 102 that supports a communication channel of mobile device 101, i.e. a Bluetooth node configured to send and receive communication to and from mobile device 101. In other embodiments, multiple wireless beacons 102 may be distributed across a target area at appropriate distances such that mobile device 101 is always in communication range of at least one wireless beacon 102. In this way, multiple wireless beacons 102 may fill in coverage area by providing additional access points.

The at least one wireless beacon 102 may receive a communication and forward the communication to a mesh network 104. Mesh network 104 may include multiple nodes, e.g., relay nodes, gateway nodes, and other client nodes. A node, in some embodiments, may be any electronic device that is in communication with another device of multi modal communication system 100 and that is selectively capable of creating, receiving, or transmitting information. Mesh network nodes can be battery powered or hardwire powered.

A relay node, in some embodiments, may be a device that is capable of relaying (forwarding and receiving) communication to other nodes. A relay node may be configured to scan for additional available network nodes and advertise its presence. A relay node may have access to Internet 107. A relay node may be configured to forward and receive communication to and from other nodes. A relay node, in some embodiments, may not be capable of communicating directly with mobile device 101 and/or Internet 107. In this way, a relay node may be a cost effective hardware device for forwarding and receiving information across mesh network 104.

Gateway node 103 may be, in some embodiments, a device that is capable of relaying (forwarding and receiving) communication to other nodes and may be additionally capable of accessing Internet 107. Gateway node 103 may scan for additional available network nodes and advertise its presence. In some embodiments, gateway node 103 may communicate with other nodes according to a first communication channel (Bluetooth) and may be capable of accessing Internet 107 according to an alternative communication channel (Wi-Fi) that is different than the first communication channel. Gateway node 103 may be capable of accessing Internet 107 or, in some embodiments, where Internet 107 is not reachable; gateway node 103 may function in a “relay” capacity, e.g, by forwarding and/or receiving communication to other nodes. In some embodiments still, gateway nodes 103 may be fixed function in that they only forward messages to a specific online service, or they may be more generic and have the ability to forward to multiple online services generally over the Internet 107. Gateway nodes 103 that provide multi-delivery options may service multiple applications and developers.

A client node may be, in some embodiments, a device that is capable of relaying (forwarding and receiving) communication to other nodes and may additionally be capable of accessing Internet 107. A client node may scan for additional available network nodes. The client node may also advertise its presence to all available network nodes within range and allow inbound connections from other client nodes. In some embodiments, a client node may be a user device, e.g., mobile device 101. A client node may also be capable of wireless communication with other nodes. This may allow the system to be more resilient to device failure, changing wireless connectivity and other environmental changes.

In some embodiments, a client node (not illustrated) may extend the range of connectivity beyond wireless beacon 102 or the other nodes of mesh network 104. In these embodiments, the client node may be an alternate mobile device (not illustrated) that may be used as an ad-hoc client node to relay messages to and from alternative communication path 106. For example, a mobile device 101 may selectively serve as a client node of mesh network 104.

In many embodiments, mesh network 104 includes multiple nodes. In some embodiments, all nodes of mesh network 104 include at least one communication channel that the mobile device 101 handles, but can use multiple communication channels and protocols to communicate from node to node, for example, 802.15, ZigBee, NFC, optical wireless, Ethernet, Wi-Fi, Bluetooth, Bluetooth Smart, Bluetooth Low Energy, etc. Furthermore, some of the individual nodes of mesh network 104 may be capable of relaying/forwarding communication (e.g., relay nodes) to other nodes and some of the individual nodes of mesh network 104 may be capable of accessing Internet 107 (e.g., gateway nodes). Wireless beacon 102 may be a node that is in communication with mobile device 101 across a Bluetooth communication channel. However, in some embodiments, wireless beacon 102 may be any node that shares at least one communication channel with mobile device 101 and a communication channel with mesh network 104. Furthermore, in some embodiments the communication channel employed between wireless beacon 102 and the mobile device 101 will be distinct from the communication channel that other nodes of the mesh network 104 use to communicate with one another.

Wireless beacon 102 may enable communication between mobile device 101 and mesh network 104. Wireless beacon 102 may be a first beacon of a group of beacons that make up alternative communication path 106. Alternative communication path 106 may consist of multiple beacons having multiple communication channels and multiple protocols. Wireless beacon 102 may be connected to mesh network 104, which may include a plurality of Bluetooth devices. The nodes in mesh network 104 may communicate with a gateway node 103, which may communicate over Internet 107 to server device 105. In some embodiments, multi modal communication system 100 provides for at least two communication paths between mobile device 101 and server device 105. The alternative communication path 106 may include any number and type of communication channels provided that at least one node can communicate with mobile device 101 and at least one node can communicate with Internet 107.

As depicted in FIG. 1, first communication path 108 may enable communication from mobile device 101 directly to server 105 via Internet 107. The alternative communication channel 106 may enable mobile device 101 to communicate directly to wireless beacon 102, then wireless beacon 102 may communicate with mesh network 104, which may communicate with gateway node 103, which may communicate to server 105 via Internet 107.

In some embodiments, server 105 may be a local device (e.g., on the same premises as other devices) and in other embodiments server 105 may be an external device (e.g., connected to other devices via a large-scale network such as the Internet). Exemplary server devices may be database servers, catalog servers, communications servers, print servers, game servers, fax servers, media servers, sound servers, proxy servers, web-servers, file servers, application servers, mail servers, and customized application specific servers. Server 105 may receive a request from mobile device 105 across first communication path 108 or alternative communication path 106 and perform processing based on the request, e.g., data processing. In turn, server 105 may remit processing results to mobile device 101 across first communication path 108 or alternative communication path 106 or both.

Server 105 may be a reliable computing device with specialized hardware such as uninterruptible power supplies, error correcting code memory (“ECC”), a redundant array of independent disks (“RAID”), processing devices, and heatsink/temperature controls such as water-cooling. In some embodiments, multiple server devices may be configured on racks and referred to singularly as a “server device” although the term customarily includes multiple server devices. Furthermore, server 105 may run any unique operating system as would be understood by a person having ordinary skill in the art, e.g., UNIX, Linux, Free Berkeley Software Distribution (“FreeBSD”), Microsoft Windows Server, and the like.

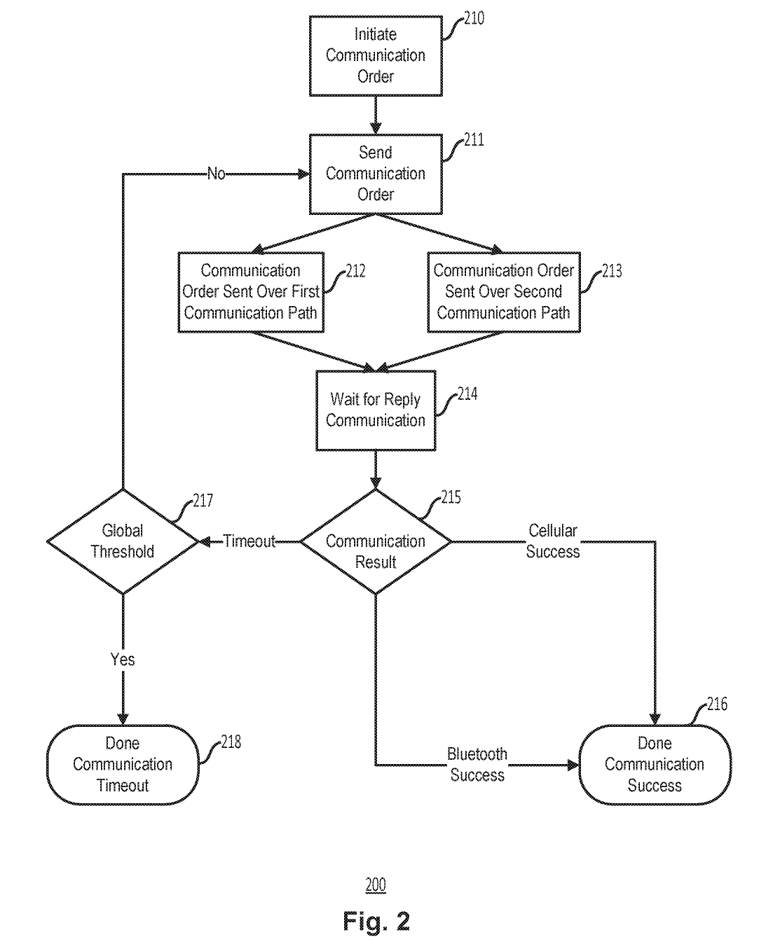

FIG. 2 is an exemplary flow chart depicting an exemplary multi modal decision process 200. Multi modal decision process 200 may be used with multi modal communication system 100. Furthermore, communications of multi modal decision process 200 are not necessarily path dependent as a single communication may be sent over multiple communication paths and/or multiple communication channels. The multi modal decision process 200 may handle resends, timeout calculations and success notifications. Moreover, in some embodiments, multi modal decision process 200 may be performed by any device or node of multi modal communication system 100 or combinations of devices and/or nodes of multi modal communication system 100.

Beginning with step 210, a device, such as mobile device 101, may initiate a communication order. Other exemplary devices may be gateway node 103, wireless beacon 102, server 105, or other exemplary devices disclosed throughout this disclosure. Next, at step 211, the device may send the communication order. The device may send the communication order over a first communication path (cellular network) in step 212 and over an alternative communication path in step 213 e.g., a Bluetooth connection. In step 214, the device connected in step 213 may wait for a reply communication, e.g., from server device 105 across the first communication path 108 or alternate communication path 106. In step 215, after receiving the reply communication, the device may determine the communication result e.g., timeout or success. In some embodiments, “timeout” may be an event that occurs automatically upon the conclusion of a pre-determined amount of time, e.g., a timeout may occur when the device has been waiting for a reply communication for a pre-determined amount of time.

In step 217, after step 215 results in “timeout,” the device may evaluate if a global timeout threshold is met. In some embodiments, “global timeout” threshold may be an event that occurs automatically upon the conclusion of a pre-determined amount of time or a pre-determined number of “timeouts.” For example, a global timeout may occur when the device has been waiting for a reply communication for a pre-determined amount of time in excess of the standard timeout or may occur when the standard timeout has occurred a predetermined number of times. At step 217, if the global timeout has been reached or exceeded (Yes), then the multi modal decision process 200 is completed at step 218 (Done Communication Timeout).

At step 217, if the global timeout threshold has not been exceeded (No), then the multi modal decision process 200 retries sending the communication order again, at step 211, to enable the device to retry sending of the communication order. A device may attempt resending the communication order upon failure any number of times as may be appropriate depending upon the nature of the communication. For example, three attempts may be appropriate for a non-sensitive communication and one attempt may be appropriate for sensitive communication containing financial information. If the device receives a success acknowledgement, multi modal decision process 200 was successful and is completed at step 216 (Done Communication Success).

In some embodiments, mobile device 101 or multiple mobile devices may extend the range of connectivity beyond any fixed installation of wireless beacons 102, relay nodes, gateway nodes 103, etc. In these embodiments, mobile device(s) 101 may be used as ad-hoc client node(s) to relay messages to and from alternative communication path 106. Each client node may scan for available network nodes, advertise its presence, and allow inbound connectivity from other client nodes. This may allow the system to be more resilient to device failure, changing wireless connectivity and other environmental changes that would otherwise disrupt connectivity to one or more nodes.

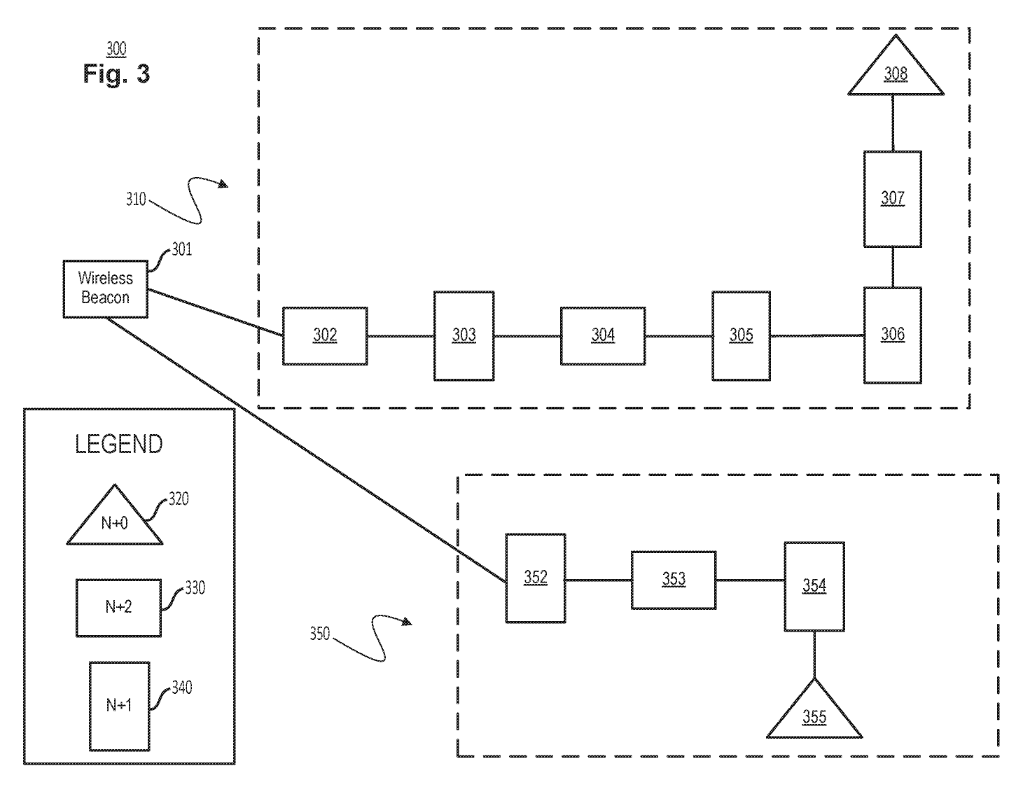

FIG. 3 is an exemplary node communication network. The exemplary node communication network 300 depicts a first node communication path 310 and a second node communication path 350. First and second node communication paths 310, 350 may be sub-parts of multi modal communication system 100, e.g., mesh network 104. Moreover, each node in node communication network 300 may calculate its individual “network distance” to other nodes and/or devices, for example, a gateway node 103 or mobile device 101, and advertise this distance across node communication network 300 and/or multi modal communication system 100.

A network distance may be understood in some embodiments as a sum of network distances associated with devices along a communication path. For example, if a communication path has three devices (X, Y, and Z), X may calculate its “network distance” to Z by summing the network distance value for itself (i.e., node X), node Y, and node Z. Each node may calculate its own network distance value based on a variety of factors, including its own connectivity, what types of nodes it is connected to, what type of connection it has to those nodes, the last successful message sent and/or received from that node, or the like. A node may combine these metrics to calculate a network distance as a number. In turn, the number may be advertised to the rest of multi modal communication system 100. In a sense, a particular nodes network distance may represent the effort and likelihood that a particular communication sent to that node will reach the Internet. In some embodiments, if a node is connected to multiple nodes the network distance may be the average of those connections.

As depicted by the legend in exemplary FIG. 3, gateway nodes, e.g., gateway nodes 308 and 355, represented by triangles, may have a network distance of N+0 (i.e., the node adds a distance of “0” to a determination of a network distance for a communications path). Client nodes, for example, 302, 304, 305, and 353, represented by horizontal rectangles, may have a network distance of N+2. Relay nodes, for example, 303, 305, 306, 307, 352, and 354, represented by vertical rectangles, may have a network distance of N+1. Furthermore, in some embodiments, any base value may be assigned to any particular node type without deviating from the aforementioned concepts.

In the exemplary embodiment represented by FIG. 3, a device's particular network distance is calculated by summing the total of the base values of each device that must be communicated with in order to reach either of gateway nodes 308, 355. Each node of first node communication path 300 is configured to calculate its individual network distance to first gateway node 308. For example, first gateway node 308 has an individual network distance of 0. In turn, fourth relay node 307 has an individual network distance of 1 and third relay node 306 has an individual network distance of 2. Second relay node 305 has an individual network distance of 3. Second client node 304 has an individual network distance of 5. First relay node 303 has an individual network distance of 6 and first client node 302 has an individual network distance of 8. Therefore, the total network distance of first node communication path 300 may be represented by the farthest out node from first gateway node 308, e.g, first client node 302 which has an individual network distance of 8.

Each node of second node communication path 350 is configured to calculate and advertise its individual network distance to second gateway node 355 in similar fashion. For example, second gateway node 355 has an individual network distance of 0. In turn, sixth relay node 354 has an individual network distance of 1. Third client node 353 has an individual network distance of 3. Fifth relay node 352 has an individual network distance of 4. Therefore, the total network distance of second node communication path 350 may be represented by the farthest out node from second gateway node 355, e.g, fifth relay node 352, which has an individual network distance of 4.

Wireless beacon 301, in a first mode, may be configured to calculate and advertise a network distance corresponding to the shortest network distance required to reach either of gateway nodes 308, 355. In the exemplary embodiment of FIG. 3, the shortest network distance may be second node communication path 350. Therefore, in a first mode, wireless beacon 301 may advertise a network distance of 4. Wireless beacon 301, in a second mode, may be configured to calculate and advertise a network distance that corresponds to the average distance required to reach either of gateway nodes 308, 355. In the exemplary embodiment of FIG. 3, the first node network path 310 may have a corresponding network distance of 8 and the second node network path 350 may have a corresponding network distance of 4. Therefore, when wireless beacon 302 is in the second mode it may advertise an average network distance of 6. Wireless beacon 301, when operating in a third mode, may advertise a network distance corresponding to the shortest network distance and may also advertise a network distance corresponding the average network distance as explained above.

Node devices and user devices of multi modal communication system 100 may optionally build a network map in order to forward communication effectively. In some embodiments, each node in multi modal communication system 100 may build a network map in order to forward messages most effectively to a destination node, which is not necessarily a gateway node. To build a network map, each node may forward to other nodes a list of connectable nodes and their individual network distances. In some embodiments, a node with only one node connection may not send any messages indicating connectivity. A node with two or more node connections would send a network connectivity message to each connected node indicating the network distance of each connected node respectively. If a node receives a network map from a connected node, it may use the network map as the basis for forwarding future messages.

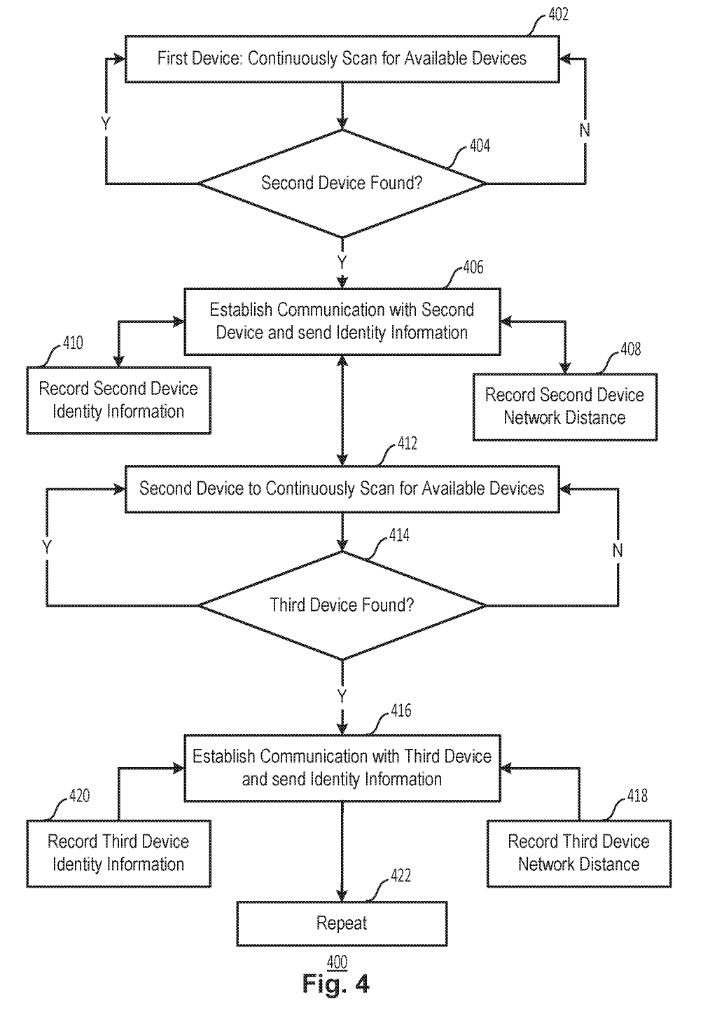

FIG. 4 is an exemplary flowchart depicting the generation of a network map 400. For ease of understanding, FIG. 4 will be explained from the perspective of three devices (not illustrated) that perform various processes. The first, second, and third devices may be, for example, a relay node, client node, gateway node, or mobile device. At step 402, the first device may continuously scan for available devices. In some embodiments, all devices and/or nodes of the multi modal communication system 100 will continuously scan for available devices. In other embodiments, only some devices and/or nodes of the multi modal communication system 100 will continuously scan for available devices, e.g., wired node devices or static repeating nodes. If, in step 404, a second device is found, the first device may establish communication with the second device and send the second device its individual identity information in step 406. Additionally, in step 402, the first device will continue to continuously scan for available devices. Once communication with the second device is established, in step 406, the first device may record the individual identity information of the second device to the network map maintained by the first device at step 410. Additionally, at step 410, the second device may add its own individual identity information to the network map maintained by the second device. Similarly, at step 408, the first device may record the network distance information of the second device to the network map maintained by the first device. Additionally, the second device may add its own individual identity information to the network map maintained by the second device at step 408. In this way, the network map may be independently maintained and shared between the first device and the newly found second device.

At step 412, the second device may continuously scan for alternate available devices. If, in step 412, a third device is found the second device may establish communication with the third device and send the third device its individual identity information in step 416. Additionally, in step 412, the second device will continue to continuously scan for available devices. Once communication with the third device is established, in step 416, the second device may record the individual identity information of the third device to the network map maintained by the second device, at step 420. Additionally, at step 420, the third device may add its own individual identity information to the network map maintained by the third device. Similarly, at step 418, the second device may record the network distance information of the third device to the network map maintained by the second device. Additionally, at step 418, the third device may add its own individual identity information to the network map maintained by the third device. In this way, the network map may be independently maintained by the first, second, and third devices.

Moreover, the first, second, and third devices may share their individual network maps with one another. In some embodiments, each device does not necessarily have to perform the recording steps independently but rather can accept a network map from an adjacent device when communication is established at a step similar to steps 406 and 416. In some embodiments, according to the aforementioned principles, if communication between the first device, second device, and or third device is lost, then the first device, second device, or third device may remove the lost device from the respective network map it maintains and send an updated network map to other devices it is in communication with.

When a device sends a particular network map communication, each device can evaluate the distance and network connectivity of each device and/or node based on the network map received. Devices can prune messages that are sent back to adjacent devices that have a significantly higher network distance. This may allow for the number of redundant paths of multi modal communication system 100 to be limited and the amount of data transmitted for network map updates to also be limited. Characteristics of the network map can be sorted, grouped by network distance, and then compressed to reduce the size of the network transmissions when sending network map updates to other devices as may be understood by a person having ordinary skill in the art.

In some embodiments, devices may continually scan for available connectivity e.g., at steps 402, 412, and 422. A combination of signal strength, node-type (gateway, relay, client), connections, distance, network hops to gateway, etc. are used to selectively decide which nodes to establish communication with, e.g., at steps 406 and 416. Depending on available nodes, a client device might connect to all available nodes, or rank and connect to only the devices with a network distance that is lower than a predetermined value. In many embodiments, the devices of the multi modal communication system 100 may leave connections available for incoming device connections from other devices and/or nodes to allow the extension of mesh network 104.

In some embodiments, a mobile device 101 such as a smartphone, may act as a client node of mesh network 104 that is configured for forwarding and receiving communication from other nodes. In other embodiments, a mobile device 101 such as a smartphone, may act as a gateway node that is configured to connect to Internet 107 and for forwarding and receiving communication from other nodes. In this way, mobile device 101 may advertise whether it has connectivity with Internet 107 and then forward messages to Internet 107 when received from other nodes. In some embodiments, forwarding by mobile device 101 may either be immediate (to reduce total system delay) or forwarding may occur if a communication timed out.

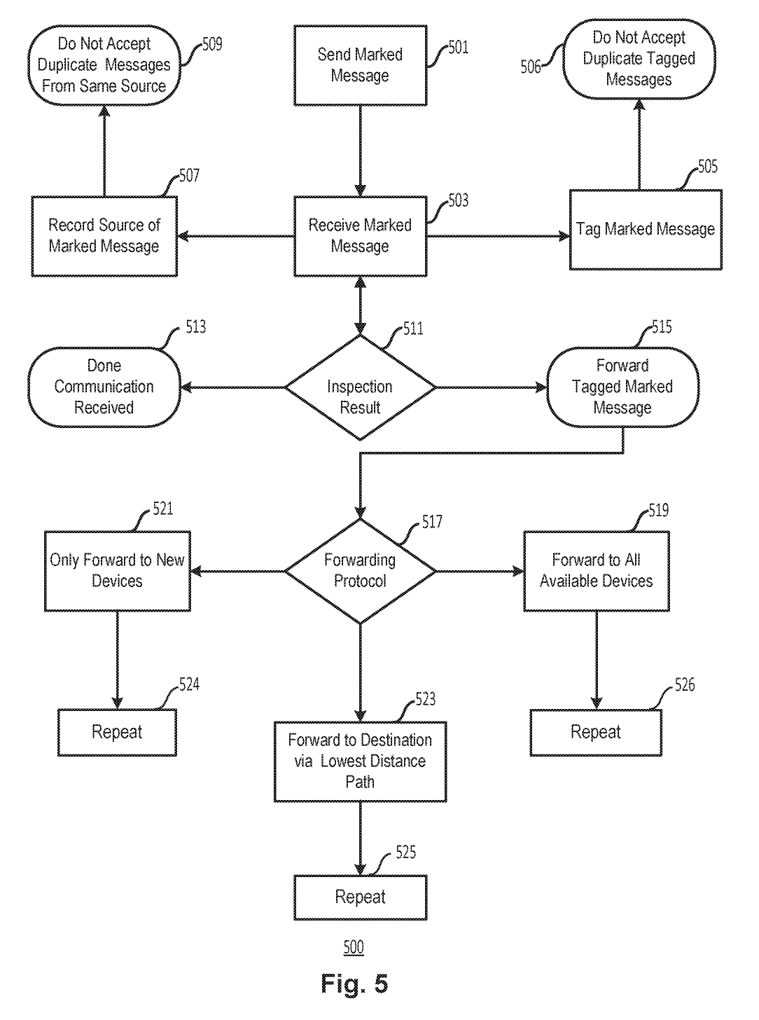

FIG. 5 illustrates an exemplary message inspection and forwarding protocol. The message inspection and forwarding protocol 500 may be performed by any device of multi modal communication system 100. Furthermore, the message inspection and forwarding protocol 500 may transmit messages between mobile device 101 and server device 105. For ease of understanding, FIG. 5 will be explained from the perspective of two devices (not illustrated). At step 501 a first device sends a marked message to a second device. In some embodiments, a marked message may be any communication that has additional information regarding the marked messages intended destination, intermediate destinations, and/or originating source information. Marked messages may be bit packed by reducing the number of messages needed to send any one particular type of marked message as would be understood by a person having ordinary skill in the art. Marked messages may be marked explicitly with the IP or DNS name of their destination. Alternatively, marked messages may use an implicit service where all marked messages are forwarded to a specific network service on the Internet. In some embodiments, marked messages intended for a specific device, such as a client node, may be marked explicitly with the device identifier or other application specific identifiers.

In step 503, the second device may receive the marked message. In some embodiments, at step 503, if the second device is a gateway device or client node in communication with the Internet, then the marked message may be sent directly to the Internet. Next, at step 505, the second device may tag the marked message. In some embodiments, at step 505, the first device may tag the marked message with implicit network location registration information. In other embodiments, at step 505, the first device may tag the marked message with explicit network location registration information. For example, the first device may tag the marked message with global location registration information that represents a physical location. In some embodiments, when marked messages are tagged, at step 505, with global location registration information, return messaging can be preferentially routed according to the global location registration information. For example, when mobile device 101 encounters a new physical network and sends a marked message at step 501, the marked message can be tagged at step 505 with global location registration information of mobile device 101, that represents the physical location of mobile device 101.

In some embodiments, the step of tagging the marked message (step 503) may impart or embed identifying information of the tagging device to the marked message. In some embodiments, a device may tag a marked message with individual identity information and/or a network map. In some embodiments still, at step 505, marked messages may be tagged by the second device to include a TTL count (“Time to Live”) in each message. Then each time the marked message and forwarding protocol is repeated, for example at steps 524, 525, and 526 and the marked message can be tagged again to include a reduced TTL count. Once the TTL value reaches zero, the marked message may no longer be forwarded according to marked message and forwarding protocol 500. This tagging approach may prevent malformed packets from flooding multi modal communication system 100 by circulating from device to device indefinitely.

In step 507, the second device may additionally or alternatively record the source of the marked message, which, in this instance may be the first device. In some embodiments, at step 507, devices and/or nodes may also keep track of all messages they have received, both globally and on a per device connection basis. In some embodiments, at step 509, the second device may refuse to accept duplicate marked messages from the same sending source. In some embodiments, at step 506, the second device may refuse to accept duplicate tagged messages. Next, at step 511, the second device may perform an inspection of the marked message. The inspection at step 511 may compare the individual identity information of the receiving device (second device) against information of the marked message. For example, the marked message may have destination information that the second device compares against the individual identity information of the second device. In some embodiments, each device and/or node of multimodal communication system 100 may then inspect all marked messages received and compare its own individual identifying information with identifying information in the marked message to determine if the marked message should be received or forwarded.

If at step 511, the destination information of the marked message and the individual identity information of the second device match, message inspection and forwarding protocol 500 ends at step 513. Conversely, if at step 511, second device determines the destination information and the individual identity information of the second device do not match then the second device forwards the tagged marked message (step 515). In some embodiments, according to the aforementioned principles any type of inspection and/or comparison may occur. Such a comparison may be premised on security concerns and/or destination, sending source, network path, network distance, network channel, and the like.

In turn, at step 517, the second device may process the tagged marked message according to a forwarding protocol. At step 519, the second device may, when operating in a first forwarding mode, forward the marked message to all devices that are in communication with it. In some embodiments, as previously mentioned, some of the devices that a marked message may be forwarded to at step 519 may refuse to accept the marked message according to the principles of step 509 and/or step 506. Furthermore, in some embodiments, step 519 may override any “do not accept” step, such as steps 509, 506, e.g., in an emergency or other distress situation. At step 526, the message inspection and forwarding protocol 500 may repeat itself by sending a marked message from one node to an alternate node similar to the principles of step 501.

At step 521, the second device may, when operating in a second forwarding mode, only forward the marked message to new devices. The second mode may be based, at least in part, on a network map of the second device or a network map of an alternate device of multi modal communication system 100 and/or the information imparted at step 505. In some embodiments, at step 521, the second device may refuse to send the marked message to a device that the message originated from, e.g., the first device. Additionally, the second device can keep track of sent marked messages and refuse to send the marked message to the same recipient twice. At step 524, the message inspection and forwarding protocol 500 may repeat itself by sending a marked message from one node to an alternate node similar to the principles of step 501.

At step 523, the second device may, when operating in a third forwarding mode, only forward the marked message to its destination via the lowest distance path. In some instances, the lowest distance path may be the lowest distance path to the Internet, e.g., gateway node 103. Step 523 may be based, at least in part, on the network map of the second device and/or a network map of an alternate device of the multi modal communication system 100 and/or the information imparted at step 505. At step 525, the message inspection and forwarding protocol 500 may repeat itself by sending a marked message from one node to an alternate node similar to the principles of step 501.

In some embodiments, step 523 may be based, at least in part, on the aforementioned individual node network distance calculations, and/or the aforementioned transmission path algorithms according to the embodiment of FIG. 3. In some embodiments still, at step 523, the second device may prevent forwarding marked messages to nodes with a higher or equal network distance as their own. In this way marked messages will continually seek lower distance nodes and never travel back “up” the multi modal communication system 100. Furthermore, this may eventually result in marked messages reaching edge nodes with the lowest distance and prevent further forwarding.

While illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. It is intended, therefore, that the specification and examples be considered as example only, with a true scope and spirit being indicated by the following claims and their full scope of equivalents.

What is claimed is:

1. A multi modal communication system for sending and receiving transmissions, comprising:
at least one server device that is configured to selectively send and receive communication across a plurality of communication paths, said communication paths comprising at least a first communication path and an alternative communication path;
a plurality of nodes, at least one node being a gateway node, a relay node, or a client node, the plurality of nodes being configured to:
communicate with the at least one server device;
communicate between respective nodes using a message routing and
forwarding protocol; and
maintain a network map, wherein
at least one of the plurality of nodes is configured to communicate wirelessly with the at least one client node; and
the gateway node is configured to directly communicate with the at least one server device via the alternative communication path.

2. The multi modal communication system of claim 1, wherein each of the plurality of nodes is configured to:
calculate a network distance to the at least one gateway node;
advertise the network distance;
scan for known available nodes;
scan for new available nodes and establish communication therewith; and
update the mesh network map in the event that:
a) communication with known available nodes is established;
b) communication with known available nodes is dropped; or
c) communication with new nodes is established

3. The multi modal communication system of claim 2, wherein communication between the plurality of nodes and the at least one server device across the alternative communication path comprises at least one marked transmission including a destination tag, and
wherein each of the plurality of nodes is further configured to:
inspect the marked transmission by comparing the destination tag with an associated respective node's individual identity information, and
determine if the marked transmission should be received or forwarded based on the inspection.

4. The multi modal communication system of claim 3, wherein the destination tag includes at least one of IP information, DNS name information, or service information.

5. The multi modal communication system of claim 3, wherein at least one node comprises a gateway node, and the forwarding protocol is configured to cause the plurality of nodes to route marked transmissions preferentially across a lowest distance path to the at least one gateway node of the alternative communication path, and
wherein the lowest distance path of the alternative communication path is determined, in a first mode, by summing advertised network distances between at least one relay node and the at least one gateway node;
wherein the lowest distance path of the alternative communication path is determined, in a second mode, using a transmission path algorithm; and
wherein the marked message is a bit packed message.

6. The multi modal communication system of claim 5, wherein each of the plurality of nodes is configured to, upon receiving a marked transmission, perform at least one of the following sets of operations:
a) record identifying information of the marked transmission and prevent receiving future marked messages with the same identifying information;
b) tag the marked transmission with identifying information, forward the marked transmission to at least one node that has not previously forwarded the marked transmission as determined on the basis of the identifying information; or
c) forward the marked transmission to all available nodes.

7. The multi modal communication system of claim 5, wherein at least one of the plurality of nodes is configured to forward a received transmission to nodes with a higher or equal network distance as compared to the network distance of the at least one node.

8. The multi modal communication system of claim 1, wherein each of the plurality of nodes is configured to selectively advertise:
whether it is capable of wireless communication with the at least one server device; and
whether it is capable of relaying communication to adjacent nodes via the mesh network.

9. The multi modal communication system of claim 1, wherein the mesh network map comprises:
all known nodes and their type;
all available nodes and their type;
a distance metric between each node for each respective known node, and wherein each of the plurality of nodes forwards the mesh network map to each known node.

10. The multi modal communication system of claim 1, wherein the plurality of nodes and the at least one server device are configured to:
communicate bit packed messages and encrypted messages.

11. The multi modal communication system of claim 1, further comprising at least one mobile device, in communication with the at least one server device, configured to selectively communicate with the at least one server device across a first communication path, an alternative communication path, or both.

12. The multi modal communication system of claim 7, wherein the mobile device is configured to advertise a current global registration via the first communication path, alternative communication path 106, or both the first and alternative communication path, and wherein the at least one server device is configured to:
transmit a return transmission to the mobile device via a shortest path distance across the alternative communication path via the mesh network to the mobile device based on the current global registration.

13. The multi modal communication system of claim 12, wherein the at least one mobile device is a client node configured to continuously:
advertise its presence;
scan for known available nodes;
scan for new available nodes and establish communication therewith; and
update the mesh network map in the event that:
communication with known available nodes is established;
communication with known available nodes is dropped; and
communication with new nodes is established.

14. A multi modal communication system for sending and receiving transmissions, comprising:
at least one server device that is configured to selectively send and receive communication across a plurality of communication paths, said communication paths further comprising at least one communication channel;
a plurality of nodes, at least one node being a gateway node, a relay node, or a client node, the plurality of nodes being configured to:
communicate with the at least one server device using a forwarding protocol;
communicate between respective nodes using the forwarding protocol according to a common communication channel;
maintain a network map;
tag marked messages, wherein
at least one of the plurality of nodes is configured to communicate wirelessly with the at least one client node; and
the at least one gateway node is configured to communicate with the at least one server device according to a first communication channel.
at least one mobile device, in communication with the at least one server device, configured to selectively communicate with the at least one server device across a first communication path, an alternative communication path, or both.

15. A method for sending and receiving transmissions, comprising:
sending a transmission across a mesh network;
receiving a transmission from the mesh network by a server device,
wherein sending the transmission includes:
relaying the transmission according to a message routing and forwarding protocol across a plurality of nodes configured as the mesh network; and
forwarding the transmission to the server device by a gateway node across the Internet.

16. The method for sending and receiving transmissions according to claim 15, further comprising:
building a mesh network map by the plurality of nodes;
maintaining the mesh network map by the plurality of nodes; and
sharing the mesh network map according to a mesh network message routing and forwarding protocol by the plurality of nodes.

17. The method for sending and receiving transmissions according to claim 16, further comprising:
advertising the presence of each of the plurality of nodes;
scanning for known available nodes;
scanning for new available nodes and establishing communication therewith; and
updating the mesh network map by adding new available nodes and removing previously added nodes that communication cannot be established with.

18. The method for sending and receiving transmissions according to claim 16, further comprising:
calculating a network distance from each of the plurality of nodes to a gateway node having Internet access; and
advertising the network distance.

19. The method for sending and receiving transmissions according to claim 16, further comprising:
determining a lowest distance path to a gateway node;
routing marked transmissions preferentially across a lowest distance path to the at least one gateway node, and
wherein the lowest distance path is determined, in a first mode, on the basis of a summation of advertised network distances between respective nodes;
wherein the lowest distance path of the alternative communication path is determined, in a second mode, on the basis of a transmission path algorithm.

20. The mobile communication system of claim 17, wherein updating the mesh network map comprises:
selectively advertising whether each of the plurality of nodes is capable of directly communicating with the server device and if it is capable of relaying communication to adjacent nodes via the mesh network.
